(19) United States
(12) Patent Application Publication
(10) Pub. No.: US 2015/0367281 A1
(43) Pub. Date: Dec. 24, 2015

(54) ABSORBENT SOLUTION FOR ABSORPTION OF ACID GAS AND PROCESS FOR ABSORPTION OF ACID GAS

(71) Applicant: Commonwealth Scientific and Industrial Research Organisation, Campbell (AU)

(72) Inventors: Graeme Douglas PUXTY, Holmesville (AU); Gilles Claude-Alain RICHNER, Bougy-Villars (CH); Paul Hubert MARIA, Floraville (AU)

(21) Appl. No.: 14/838,608

(22) Filed: Aug. 28, 2015

Related U.S. Application Data
(63) Continuation-in-part of application No. PCT/AU2014/000859, filed on Aug. 29, 2014.

(30) Foreign Application Priority Data
Aug. 29, 2013 (AU) 2013903284
Mar. 25, 2014 (AU) 2014901053
Dec. 10, 2014 (AU) 2014905002

(51) Int. Cl. B01D 53/62

(52) U.S. Cl. CPC B01D 53/62; B01D 2252/20421

(57) ABSTRACT

An aqueous composition and process for absorbing a target acidic gas from a gas stream rich in the target acidic gas, the aqueous composition comprising at least one absorbent compound comprising benzylamine and/or substituted benzylamine dissolved in the aqueous composition, wherein the aqueous composition comprises a co-solvent which reduces the vapour pressure of the absorbent compound in aqueous solution.

### FIELD OF THE INVENTION

The present invention is directed to an absorbent solution for absorbing an acidic gas, such as carbon dioxide, from a gas stream and a process for removing acidic gas from a gas stream.

### BACKGROUND OF THE INVENTION

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

Waste gas emissions are of significant concern, and the presence of certain gaseous constituents in a waste gas stream can result in air pollution. There is significant research into methods for treating waste gas streams to remove these gaseous constituents from waste gas streams. Carbon dioxide (CO₂) emissions, in particular, attract a great deal of attention and the discussion of waste gas emissions that follows will largely be in respect of carbon dioxide. However, the skilled addressee will appreciate that much of this discussion is also applicable to other waste gases.

There is growing pressure for stationary producers of greenhouse gases to dramatically reduce their atmospheric emissions. Of particular concern is the emission of carbon dioxide (CO₂) into the atmosphere. One method of reducing atmospheric CO₂ emissions is through its capture and subsequent storage in geological or deep sea reservoirs.

The process for capturing CO₂ from power station or combustion device flue gases is termed post combustion capture. In post combustion capture, the CO₂ in flue gas is first separated from nitrogen and residual oxygen using a suitable solvent in an absorber. The CO₂ is then removed from the solvent in a process called stripping (or regeneration), thus allowing the solvent to be reused. The stripped CO₂ is then liquefied by compression and cooling, with appropriate drying steps to prevent hydrate formation. Post combustion capture in this form is applicable to a variety of stationary CO₂ sources including power stations, steel plants, cement kilns, calciners and smelters.

Aqueous amine solutions and alkanolamine solutions in particular, have been investigated as solvents in post combustion CO₂ capture. The capture process involves a series of chemical reactions that take place between water, the amine and carbon dioxide. Amines are weak bases, and may undergo acid-base reactions. Once dissolved into the amine solution, the aqueous CO₂ reacts with water and the neutral form of the amine react to generate carbonic acid (H₂CO₃), aqueous bicarbonate (HCO₃⁻) ions and aqueous carbonate (CO₃²⁻) ions, according to the generally acknowledged equations described below:

CO₂+2H₂O [symbol] HCO₃⁻+H₃O⁺ (equation 1)

CO₂+OH⁻ [symbol] HCO₃⁻ (equation 2)

CO₃²⁻+H₃O⁺ [symbol] HCO₃⁻+H₂O (equation 3)

HCO₃+H₃O⁻ [symbol] H₂CO₃+H₂O (equation 4)

OH⁻+H₃O⁺ [symbol] 2H₂O (equation 5)

R^{a}R^{b}R^{c}N+H₃O⁺ [symbol] R^{a}R^{b}R^{c}NH⁺ (equation 6)

If the amine contains a primary (R^{a}R^{b}NH, R^{b}═H) or secondary amine (R^{a}R^{b}NH, R^{b}≠H), an additional reaction pathway becomes available, where carbon dioxide and the primary or secondary amine react to generate a carbamate (R^{a}R^{b}NCoo⁻). The carbamate may also then participate in acid-base chemistry, according to the generally acknowledged reactions described below. Tertiary amines (R^{a}R^{b}R^{c}N, R^{a}, R^{b}, R^{c}≠H) cannot form carbamates.

CO₂+R^{a}R^{b}NH+H₂ [symbol] R^{a}R^{b}NCOO⁻+H₃O⁺ (equation 7)

R^{a}R^{b}NCOO⁻+H₃O⁺ [symbol] R^{a}R^{b}NCOOH (equation 8)

It is generally acknowledged that the molar absorption capacity of an aqueous amine solution, as measured by the number of moles of CO₂ absorbed per mole of amine functionality in solution (a), is dependent upon the pH equilibria that operate in the amine solution and the formation of carbamate species.

Carbamate formation by primary and secondary amines is a direct reaction between the amine nitrogen and CO₂. This reaction consumes two moles of amine per mole of CO₂ absorbed. One mole is amine that is converted to carbamate, and the second is amine that accepts the proton released by carbamate formation. Carbamate is also a base, as illustrated by the reaction of equation 8 to form carbamic acid. However, it is a much weaker base than an amine and as such does not contribute as a proton acceptor at typical CO₂ absorption conditions. The stability of the carbamate species is influenced only weakly by temperature (the reaction enthalpy is small).

CO₂ desorption is achieved by heating of an aqueous amine solution containing CO₂. The two major effects of heating are to reduce the physical solubility of CO₂ in the solution, and to reduce the pKₐ of the amine resulting in a concomitant reduction in pH and in CO₂ absorption capacity, the net effect of which is CO₂ release. The extent of the reduction in pKₐ is governed by the enthalpy of the amine protonation reaction which in turn is governed by the amine chemical structure. All the other reactions, including carbamate formation, have small reaction enthalpies and are insensitive to temperature. Typically, the enthalpy of amine protonation is four to eight times larger than the enthalpies of the carbonate reactions and two to four times larger than the enthalpy of carbamate formation. It is the lowering of the pH upon heating that drives the reversal of carbamate and carbonate/bicarbonate formation during desorption, rather than any significant reduction in stability.

The cyclic capacity (α_{cyclic}) of an aqueous amine solution is defined as the moles of CO₂ that can be absorbed and released per mole of amine by cycling the absorbent between low temperature (α_{rich}) and high temperature (αₗₑₐₙ): α_{cyclic}=α_{rich}−αₗₑₐₙ. In terms of chemistry, this cyclic capacity is primarily governed by the change in amine pKₐ with temperature. The larger this cyclic capacity, the more efficient the amine. 30 wt % monoethanolamine (MEA, HO—CH₂—CH₂—NH₂), which is currently employed in industrial CO₂ capture, possesses an undesirable cyclic capacity of approximately α_{cyclic}=0.11 (40° C.-80° C.)

In summary, there exists a relationship between the change in amine pKₐ as a function of temperature, and the cyclic capacity of CO₂ absorption and release of an aqueous amine.

Identification of the problem with CO₂ absorption cyclic capacity has prompted efforts aimed at seeking amines with improved cyclic capacities. However, amines used for industrial CO₂ capture that achieve larger CO₂ cyclic absorption capacity than MEA have poor rates of CO₂ absorption. Slow CO₂ absorption rates are undesirable because to achieve the requisite absorption of CO₂ longer gas-liquid contact times are required which means larger absorption columns and greater capital cost. The benefits gained through increased cyclic capacity are thus offset by the disadvantages associated with decreased rates.

Amines such as MEA also suffer from oxidative and thermal degradation due to exposure to molecular oxygen in flue gas, and heating to release absorbed CO₂. This degradation requires ongoing reclamation and replenishment of the absorbent solution at considerable cost.

Amines such as MEA are also limited in the maximum concentration that can be used due to corrosion and viscosity. MEA is limited to 30 wt % as at higher concentrations it becomes too corrosive for use in contact with carbon steel. Another amine 2-amino-2-methyl-propanol (AMP, HO—CH₂—C(CH₃)₂—NH₂), which is also currently employed in industrial CO₂ capture, is also limited to around 30 wt % due to high viscosity.

Richner, Energy Procedia 37 (2013) 423-430 discloses an investigation of benzylamine as a potential solvent for carbon dioxide capture and reports some results. We have found as a result of our further work testing benzylamine in a pilot scale CO₂ absorption facility, that benzylamine develops a relatively high vapour pressure in aqueous solutions detracting from the advantages reported by Richner. We observed emission of unreacted benzylamine from the absorber column during operation. This emitted benzylamine further reacted with residual CO₂ in the gas stream forming a precipitate and blocking the absorber outlet as well as resulting in a reduction in capture performance of the absorbent.

There thus exists a need to identify amines whose aqueous solutions possess improved properties for application in gas capture technologies, such as CO₂ capture technologies.

### SUMMARY OF THE INVENTION

The vapour pressure of benzylamine and/or substituted benzylamine and the solubility of the acid gas (such as CO₂) product from their reaction in aqueous solution can be addressed by the addition of a co-solvent.

In one aspect we provide a process for absorbing target acidic gas from a gas stream rich in the target acidic gas comprising contacting the gas stream with an aqueous composition comprising at least one absorbent compound comprising benzylamine and/or substituted benzylamine dissolved in the aqueous composition wherein the aqueous composition comprises a co-solvent which reduces the vapour pressure of the absorbent compound in the aqueous solution.

In one aspect of the invention there is provided an aqueous composition for absorbing target acidic gas from a gas stream rich in the target acidic gas, the aqueous composition comprising at least one absorbent compound comprising benzylamine and/or substituted benzylamine dissolved in the aqueous composition, wherein the aqueous composition comprises a co-solvent which reduces the vapour pressure of the absorbent compound in aqueous solution.

The vapour pressure of benzylamine and/or substituted benzylamine and the solubility of the CO₂ product from the reaction with CO₂ in aqueous solution can be addressed by the addition of a co-solvent. The role of the co-solvent is to interact with both the non-polar functionality of the benzene ring in benzylamines and the polar solvent water. The interaction with water can be via hydrogen bonding, polar interactions or both.

The co-solvent will typically have both non-polar and polar character and may have functional groups capable of hydrogen bonding.

In a preferred embodiment the Relative Energy Difference solubility parameter (RED) of the co-solvent in each of benzylamine and water is no more than 1.2, preferably no more than 1.1 such as no more than 1. In one set of embodiments the RED of the co-solvents for each of benzylamine and water is in the range of from 0.3 to 1.2 such as 0.3 to 1.1 or 0.3 to 1. In a preferred set of embodiments the RED of the co-solvent in benzylamine is in the range of from 0.4 to 1.2 such as 0.4 to 1.1 or 0.4 to 1 and the RED of the co-solvent in water is in the range of from 0.3 to 1.1, such as 0.4 to 1.1, 0.4 to 0.9 or 0.4 to 0.75

In one set of embodiments the benzylamine and/or substituted benzylamine has an vapour pressure in the aqueous composition in the absence of the co-solvent which is in practice is greater than the theoretical vapour pressure determined by Raoult's law and the co-solvent provides a vapour pressure of no more than said theoretical vapour pressure. The amount of co-solvent may be determined having regard to the extent of reduction in vapour pressure which is required and the Hansen solubility parameters.

The aqueous composition and process comprising the co-solvent preferably maintains a vapour pressure of benzylamine/and or substituted benzylamine in the aqueous solution of below 0.04 kPa at 40° C. In a particularly preferred embodiment the absorbent comprises benzylamine and the aqueous composition and process comprising the co-solvent preferably maintains a vapour pressure of benzylamine in the aqueous solution of below 0.04 kPa at 40° C.

It is particularly preferred, in order to significantly reduce the vapour pressure in solution, that the co-solvent has a boiling point above the acid gas stripping temperature. In the case of CO₂ the stripping temperatures may be in the range of 120-150° C. It is preferred where the acid gas is CO₂ that the boiling point of the co-solvent is at least 150° C. and more preferably at least 170° C. The co-solvent will generally be thermally stable at the acid gas stripping temperature such as stable at a temperature of at least 150°.

### DEFINITIONS

The co-solvent in one set of embodiments is selected from co-solvents having a defined range of values of the Relative Energy Difference solubility parameter (RED) in water and in benzylamine. Relative Energy Difference solubility parameter (RED) is determined using Hansen Solubility Parameters (Charles M. Hansen, Hansen Solubility Parameters—A Users Handbook, 2^{nd} Edition, CRC Press, 2007). The Hansen Solubility Parameters are 3 terms reflecting dispersion (δ_{D}), polar (δ_{P}) and hydrogen bonding (δ_{H}) interactions between solvent and solute molecules. The “distance” (Rα) between the solubility parameters of two different materials (1 and 2) reflects the likelihood that one will be soluble in the other. The smaller the distance the greater the solubility.)

(Ra)²=4(δ_{D2}−δ_{D1})²+(δ_{P2}−δ_{P1})²+(δ_{H2}−δ_{H1})²

If two materials are soluble in each other it is a requirement that Ra be less than R₀. R₀ is known as the Hansen interaction radius and the ratio Rₐ/R₀ as the Relative Energy Difference (RED).

$$R E D = \frac{{R}_{a}}{{R}_{0}}$$

A RED of <1.0 indicates high solubility, close to 1.0 indicates a boundary condition and >1.0 indicates progressively decreasing solubility. In addition it is preferable for a co-solvent to have large values of δ_{P} and/or δ_{H} as these reflect the polar and hydrogen bonding characteristics desirable in the co-solvent.

The term hydrocarbyl is used herein to refer to a hydrocarbon substituent group which may be aliphatic or aromatic or comprise both aliphatic and aromatic components.

### DETAILED DESCRIPTION

Examples of suitable classes from which suitable co-solvents may be chosen are selected from the group consisting of aniline and aniline derivatives, glycols and glycol derivatives selected from glycol ethers, glycol esters and glycol ether esters, long chain and aromatic alcohols, amides, esters, phosphates, amines, nitrogen containing heteroaromatics, organic carbonates and organosulfur compounds.

The co-solvents may include glycols and glycol derivatives, particularly glycol mono ethers, glycol di-ethers, glycol ester ethers, glycol monoesters and glycol diesters.

One group of co-solvents are glycols. The glycols may be C1 to C8 alkylene glycols such as ethylene glycol, propylene glycol and butylene glycol; di-alkylene, tri-alkylene and tetra-alkylene glycols such as diethylene glycol and triethylene glycol, tetraethylene glycol, dipropylene glycol and tripropylene glycol; and polyalkylene glycols (preferably of molecular weight 200-600) such as polyethylene glycols (PEGs) including PEGs of molecular weight in the range of from 200 to 600 such as PEG 200 PEG 400 and PEG 600. Specific examples of glycols include ethylene glycol, propylene glycol, diethylene glycol, tripropylene glycol and tetraethylene glycol.

Preferred glycol monoethers and diethers are formed with hydrocarbyl groups of from 1 to 14 carbon atoms which hydrocarbyl groups may comprise aromatic and/or aliphatic groups. More preferred are generally the alkyl ethers of glycols such as mono-(C₁ to C₆ alkyl) ethers and di-(C₁ to C₆ alkyl) ethers of glycols selected from mono-(C₂ to C₄ alkylene) glycols, di-(C₂ to C₄ alkylene) glycols and tri-(C₂ to C₄ alkylene) glycols (particularly mono ethylene glycol, di-ethylene glycol and tri-ethylene glycol and mono-propylene glycol, di-propylene glycol and tri-propylene glycol and poly(alkylene glycol) such as polyalkylene glycol of molecular weight 200 to 600 including PEG 200-600). Specific examples of suitable monoethers of glycols and di-ethers of glycols are formed with C₁ to C₄ alkyl such as selected from the group consisting of diethylene glycol propyl ether, diethylene glycol methyl ether, diethylene glycol diethylene glycol butyl ether, diethylene glycol ethyl ether, tri-propylene glycol methyl ether, 2-phenoxyethanol di-propylene glycol butyl ether.

The glycol ether esters will generally comprise a (C₁ to C₆ alkyl) ether group and a C₁ to C₆ alkanoyl ester group of glycols selected from mono-(C₂ to C₄ alkylene), di-(C₂ to C₄ alkylene) and tri-(C₂ to C₄ alkylene) glycols (particularly mono-.di- and tri-ethylene glycol and mono, di- and tri-propylene glycol) and poly(alkylene glycol) particularly polyalkylene glycol of molecular weight 200 to 600 such as PEG 200-600. Specific examples of glycol ether esters may be selected from glycol ether esters comprising a C₁ to C₄ alkyl ether and a C₁ to C₄ alkanoyl ester groups such as selected from the group consisting of diethylene glycol butyl ether acetate, diethylene glycol ethyl ether acetate and dipropylene glycol methyl ether acetate,

The glycol derivative may be a mono-C₁ to C₆ alkanoyl or di-C₁ to C₆ alkanoyl ester of glycols selected from mono-(C₂ to C₄ alkylene), di-(C₂ to C₄ alkylene) and tri-(C₂ to C₄ alkylene) glycols (particularly mono-ethylene glycol, di-ethylene glycol, tri-ethylene glycol, mono-propylene glycol, di-propylene glycol, tri-propylene glycol) and poly(alkylene glycol) such as polyalkylene glycol of molecular weight 200 to 600 including PEG 200 to 600. Specific examples of mono and diesters of glycols include monoesters and diesters of glycols formed with C₁ to C₄ alkanoyl such as selected from the group consisting of propylene glycol diacetate, ethylene glycol dibutyrate and ethylene glycol diacetate.

One preferred class of co-solvents are diethylene glycol mono alkyl ethers and triethylene glycol mono alkyl ethers wherein the alkyl is selected from methyl, ethyl, propyl and butyl and more preferred are diethylene glycol monobutyl ether and diethylene glycol butyl ether acetate.

A further group of co-solvents are selected from the group consisting of aniline and substituted anilines where the substituent may be selected, for example, from the group consisting of one or more C₁ to C₄ alkyl groups. Specific examples of anilines may be selected from the group consisting of aniline and 2,4-dimethylaniline.

A further group of co-solvents may be selected from the group consisting of aliphatic and aromatic alcohols such as C₆ to C₁₄ alcohols selected from aliphatic alcohols, aromatic alcohols, aromatic substituted aliphatic alcohols and aliphatic substituted aromatic alcohols. Specific examples of such alcohols include 1-octanol, 2-octanol, decyl alcohol, benzyl alcohol, 2-ethyl-1-hexanol and 2-methyl-2,4-pentanediol.

A further group of co-solvents is the amides selected from formamides, acetamides and cyclic amides (lactams) which may be C₁ to C₈ alkyl formamides and C₁ to C₆ alkyl formamides substituted in the alkyl group by a substituent selected from hydroxyl and C₁ to C₆ alkoxy. Cyclic amides include 5 and 6 membered cyclic amides optionally substituted by C₁ to C₆ alkyl, particularly pyrrolidone and N-substituted pyrrolidone such as N—C₁ to C₄ alkyl pyrrolidone such as N-methylpyrrolidone. Examples of a formamide co-solvent include formamide and methoxyisopropyl formamide. Examples of acetamides include alkylacetamides such as C₁ to C₆ acetamides, di-(C₁ to C₆ alkyl) acetamides and alkyl acetamides substituted on said alkyl by a substituent selected from hydroxyl and C₁ to C₄ alkoxy. Specific examples of acetamides include methoxypropyl acetamide and methoxyisopropyl acetamide.

The co-solvent may be an ester such as an acetate ester formed between an acid selected from C₂ to C₂₀ aliphatic acids and alcohols and polyols selected from C₁ to C₁₀ hydrocarbyl alcohols and polyols. Example of ester co-solvents are 2-ethylhexyl acetate, ethyl octanoate and methyl oleate.

The co-solvent may be a mono or di-ester if a diacid such as a C₄ to C₁₀ di-acid wherein the alcohol portions are C₁ to C₆ alkanol. An example of such as co-solvents include diethyl succinate, diethyl phthalate, dimethyl phthalate, di-n-butyl phthalate, n-butyl benzyl phthalate and di-n-butyl sabacate.

The co-solvent may be a ketone comprising two hydrocarbyl groups independently selected from C₁ to C₁₂ alkyl, C₅ to C₆ aryl, C₆ to C₁₀ aryl substituted alkyl, C₆ to C₁₀ alkyl substituted aryl and carbocyclic ketones of from 5 to 6 constituent ring members optionally substituted by C₁ to C₄ alkyl. Examples of ketones include isobutyl heptyl ketone and acetophenone.

The co-solvent may be a phosphate ester such as a di-(C₁ to C₈ alkyl) or tri-(C₁ to C₈ alkyl) phosphate such as trimethyl phosphate or triethyl phosphate.

The co-solvent may be a nitrogen containing heteroaromatic containing from 1 to 3 nitrogen atoms in a 5 or 6 membered heteroaromatic ring, optionally containing one further heteroatom selected from oxygen and sulphur, which may optionally be substituted. Examples of substituents include one or two substituents independently selected from halo (such as chloro) and C₁ to C₆ alkyl. Examples of heteroaromatic rings include pyrrole, imidazole, pyrazole, triazole, thiadiazole, pyridine, pyrimidine, pyrazine and triazine. More preferred nitrogen containing heteroaromatics include imidazoles and triazoles such as 1,2,3-triazoles and 1,2,4-triazoles. Preferred heteroaromatic are the imidazoles such as imidazole which may be unsubstituted or substituted by one or two C₁ to C₆ alkyl groups. Still more preferred imidazoles are imidazole and 1,2-dimethyl imidazole. More examples of suitable imidazoles are described later in the specification. Preferred triazoles include 1,2,3-triazole and 1,2,4-triazole, more preferably 1,2,4-triazole. Preferred pyridines include dichloropyridine.

The co-solvent may be an amine such as selected from the group of primary, secondary and tertiary amines wherein the amine may be part of a heterocyclic ring of from 1 to 6 ring members. The nitrogen may be substituted by a substituent selected from C₁ to C₂₀ aliphatic and C₁ to C₆ alkyl substituted by hydroxyl, glycol or PEG of molecular weight 200 to 600. Examples of such compounds may be selected from the group consisting of N-formyl morpholine, diethanolamine, triethanolamine, monoethanolamine and diglycolamine.

The co-solvent may be a substituted carbonate such as a di-C₁ to C₂₀ aliphatic corbonate. Examples of such carbonates include 1,2-dodecane carbonate ethylene carbonate, and cyclic carbonates such as propylene carbonate.

The co-solvent may be an organic sulphur compound such as di(C₁ to C₁₀ hydrocarbyl) sulfoxides such as DMSO, di(C₁ to C₁₀ hydrocarbyl)sulfones and cyclic sulfones such as sulfolane.

The co-solvent may be a phosphoramide such as hexamethylphosphoramide.

Specific examples of preferred co-solvents may be selected from the group consisting of aniline, ethylene glycol 2-ethylhexyl ether, 2,4-dimethylaniline, benzyl alcohol, decyl alcohol, 1-octanol, diethylene glycol propyl ether, 1,2-butylene carbonate, methoxypropyl acetamide, methoxyisopropyl acetamide, diethylene glycol butyl ether acetate, 1,2-hexane carbonate, 2-octanol, 1,2,3-triazole, 2-ethylhexyl acetate, methoxyisopropyl formamide, diethylene glycol ethyl ether acetate, diethyl succinate, 2-ethyl-1-hexanol, diethylene glycol methyl ether, diethylene glycol butyl ether, diethyl succinate, 2-ethyl-1-hexanol, propylene glycol diacetate, ethylene glycol dibutyrate, tetraethylene glycol, 1,2-decane carbonate, diethylene glycol ethyl ether, 1,2-dodecane carbonate, tripropylene glycol methyl ether, ethylene glycol diacetate, triethyl phosphate, hexamethylphosphoramide, dipropylene glycol methyl ether acetate, 1,2-dimethyl imidazole, N-formyl morpholine, acetophone, di-n-butyl phthalate, N-methyl-2-pyrrolidinone, ethyl octanoate, dimethyl phthalate, diethyl phthalate, tri-n-butyl phosphate, 2-methyl-2,4-pentanediol, tripropylene glycol, benzonitrile, dipropylene glycol butyl ether, diethanolamine, n-butyl benzyl phalate, triethylene glycol, dimethyl sulfoxide, triethanolamine, iso-butyl heptyl ketone, methyl oleate, trimethyl phosphate, 2-pyrrolidinone, di-n-butyl sebacate, 2-phenoxyethanol, propylene glycol, sulfolane, toluene diisocyanate, diethylene glycol, monoethanolamine, ethylene glycol, propylene carbonate, diglycolamine, dipropylene glycol, ethylene carbonate and formamide.

In one set of embodiments the co-solvent comprises at least one selected from the group consisting of cyclic amides, glycols, sulfolane and nitrogen containing heteroaromatics, particularly imidazole, triazoles and pyridine wherein said heteroaromatics are optionally substituted with one or two substituents independently selected from C₁ to C₆ alkyl and chloro.

In one set of embodiments the co-solvent is selected from the group consisting of ethylene glycol, imidazole, 1,2-dimethylimidazole, 1-methyl-2-pyrrolidone, dichloropyridine, sulfolane and 1,2,4-triazole.

In one embodiment alkanolamine gas absorbents are only present in combination with other co-solvents. The co-solvent component preferably does not include alkanolamine acid gas absorbents such as MEA, DEA or mixtures thereof.

The optimum concentration of co-solvent in the composition will depend on the concentration of benzylamine and/or substituted benzylamine and the specific absorbent used. The co-solvent will typically be used in amounts in the range of from 1% to 20% by volume based on the volume of the aqueous composition.

In one set of embodiments the volume ratio of co-solvent:bezylamine and/or substituted benzylamine is in the range of from 1:20 to 1:1 and more preferably from 1:10 to 1:1. Benzylamine and or substituted benzylamine is preferably present in an amount of 1% to 50% v/v of the composition, preferably 10% to 50% v/v and most preferably benzylamine is present in 10% to 50% v/v of the aqueous composition.

The benzylamine and/or substituted benzylamine may be one or more compound of formula (1):

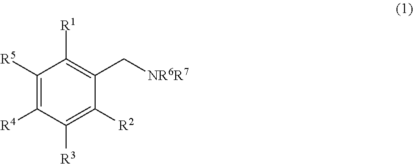

wherein R¹ to R⁵ are each independently selected from the group consisting of: H, hydroxyl, alkyl hydroxyl, alkoxy, substituted or unsubstituted C₁ to C₂₀ alkyl, substituted or unsubstituted C₂ to C₂₀ alkenyl, substituted or unsubstituted C₂ to C₂₀ alkynyl, substituted or unsubstituted aryl, substituted or unsubstituted heterocycle, substituted or unsubstituted carbonyl, aldehyde, substituted or unsubstituted carboxylate, substituted or unsubstituted ester, substituted or unsubstituted C₁ to C₂₀ alkoxy, substituted or unsubstituted carboxamide, substituted or unsubstituted imine, NR⁶R⁷, N═CR⁸R⁹, and halo; and

R⁶ and R⁷ are each independently selected from the group consisting of: H, substituted or unsubstituted C₁ to C₂₀ alkyl, substituted or unsubstituted C₂ to C₂₀ alkenyl, and substituted or unsubstituted C₂ to C₂₀ alkynyl;

wherein R⁸ and R⁹ are independently selected from the group consisting of H, substituted or unsubstituted C₁ to C₂₀ alkyl, substituted or unsubstituted C₂ to C₂₀ alkenyl, and substituted or unsubstituted C₂ to C₂₀ alkynyl substituted or unsubstituted aryl, substituted or unsubstituted heterocycle, substituted or unsubstituted carbonyl, aldehyde, substituted or unsubstituted carboxylate, substituted or unsubstituted ester, substituted or unsubstituted alkoxy, substituted or unsubstituted carboxamide, substituted or unsubstituted imine, NR⁶R⁷, and halo; and

when any of R¹ to R⁵ is a substituted C₁ to C₂₀ alkyl, the substituted C₁ to C₂₀ alkyl is selected from the group consisting of: haloalkane, alkylsulfide, hydroxyalkyl, alkyl thiol, alkyl phosphine, alkyl phosphate, alkyl phosphonate, alkyl ether, alkyl alkanoate, alkyl hydroperoxide alkyl peroxide, alkyl cyanate, alkyl isocyanate, alkyl nitrate, alkyl cyanide, alkyl amide, alkyl imine, alkyl imide, alkyl azide, alkyl diazine, and alkyl nitrite.

The compound of formula (1) may be benzylamine (where R¹ to R⁷ are all hydrogen) or may be a substituted benzylamine where preferably at least one of R¹ to R⁷ (preferably at least one of R¹ to R⁵) comprise a functional group having one or more atoms capable of hydrogen bonding in an aqueous composition where the hydrogen bonding atoms are spaced from the benzylamine group by at least one carbon atom. Where the absorbent comprises a substituted benzylamine it is preferred that no more than 3 of R¹ to R⁷ (preferably at least one of R¹ to R⁵) comprise a functional group having one or more atoms capable of hydrogen bonding in an aqueous composition where the hydrogen bonding atoms are spaced from the benzylamine group by at least one carbon atom.

Preferably, the substituted benzylamine comprises the substituent in the para position of the benzylamine (R⁴ in formula (1)).

Preferably, where the absorbent is a substituted benzylamine no more than one of R¹ to R⁵ is an alkyl amine. In one embodiment, none of R¹ to R⁵ are alkyl amine. Preferably, none of R¹ to R⁵ is an alkyl aryl. Preferably, no more than three, more preferably not more than two and even more preferably no more than one of R¹ to R⁵ comprises a substituted or unsubstituted C₁ to C₂₀ alkyl. In another embodiment, no more than three, more preferably not more than two and even more preferably no more than one of R¹ to R⁵ comprises a substituted or unsubstituted C₁ to C₅ alkyl. Examples of substituted C₁ to C₅ allyl include substitution with a substituent selected from the group consisting of hydroxyl, thiol, amino, alkoxy and carboxyl.

The group substituted or unsubstituted carbonyl may be acyl such as a hydrocarbyl-carbonyl where the hydrocarbyl may be selected from group consisting of aryl, C₁ to C₂₀ alkyl, C₂ to C₂₀ alkenyl and C₂ to C₂₀ alkynyl.

The group substituted or unsubstituted carboxyl may be carboxyl or hydrocarbyloxycarbonyl wherein the hydrocarbyl is selected from the group consisting of aryl, C₁ to C₂₀ alkyl, C₂ to C₂₀ alkenyl and C₂ to C₂₀ alkynyl.

The group substituted or unsubstituted ester may be an acyloxy wherein the group acyl is hydrocarbyl-carbonyl where the hydrocarbyl may be selected from group consisting of aryl, C₁ to C₂₀ alkyl, C₂ to C₂₀ alkenyl and C₂ to C₂₀ alkynyl.

More preferably at least one of R′ to R⁵ is a group capable of hydrogen bonding selected from the group consisting of hydrox-C₁ to C₄ alkyl (such as hydroxymethyl, 2-hydroxyethyl. 2-hydroxypropyl, 3-hydroxypropyl), carboxyl, carbamoyl, (C₁ to C₄ alkyl)carbamoyl (such as N-methylcarbamoyl and N-ethylcarbamoyl), di-(C₁ to C₄ alkyl)carbamoyl (such as N,N-dimethylcarbamoyl and N,N-diethylcarbamoyl), (C₁ to C₄ alkoxy)carbonyl (such as methoxycarbonyl and ethoxycarbonyl) and C₁ to C₄ alkanoyl such as acetyl, C1 to C4 alkyl such as methyl ethyl or propyl substituted with a substituent selected from carboxyl, carbamoyl, (C₁ to C₄ alkyl)carbamoyl (such as N-methylcarbamoyl and N-ethylcarbamoyl), di-(C₁ to C₄ alkyl)carbamoyl (such as N,N-dimethylcarbamoyl and N,N-diethylcarbamoyl), (C₁ to C₄ alkoxy)carbonyl (such as methoxycarbonyl and ethoxycarbonyl) and C₁ to C₄ alkanoyl (such as acetyl). In one embodiment one of R1 to R5 is said group capable of hydrogen bonding and the others are independently selected from hydrogen and C₁ to C₄ alkyl.

The substituted benzylamines are particularly useful in absorption of acidic gas in aqueous solution when benzylamine is para-substituted by the substituted alkyl having a group capable of hydrogen bonding. Accordingly, in the compound of Formula (1) it is therefore preferred that the group R⁴ is selected from the group consisting of carboxyl, (C₁ to C₄ alkoxy)carbonyl, C₁ to C₄ alkanoyl, carbamoyl, (C₁ to C₄ alkyl)carbamoyl, di-(C₁ to C₄ alkyl)carbamoyl and substituted C₁ to C₄ alkyl wherein the substituent selected from the group consisting of hydroxyl, thiol, C₁ to C₄ alkoxy, C₁ to C₄ alkylthio, amino, C₁ to C₄ alkylamino, di(C₁ to C₄ alkyl)amino, carboxyl, (C₁ to C₄ alkoxy)carbonyl, C₁ to C₄ alkanoyl, carbamoyl, (C₁ to C₄ alkyl)carbamoyl and di-(C₁ to C₄ alkyl)carbamoyl.

Specific examples of benzylamine and/or substituted benzylamine compounds of formula (1), with polar substituents able to hydrogen bond are benzylamine and the substituted benzylamines listed below:
(i) (4-(aminomethyl)phenyl)methanol (Cpd 1);
(ii) 2-(4-(aminomethyl)phenyl)ethan-1-ol (Cpd 2);
(iii) 3-(4(aminomethyl)phenyl)propan-1-ol (Cpd 3);
(iv) (3-aminomethyl)phenyl)methanol (Cpd 4);
(v) (2-(aminomethylphenyl)methanol (Cpd5);
(vi) 4-(aminomethyl)-N,N-dimethylbenzylamide (Cpd 6);
(vii) 2-(4-(aminomethyl)phenyl)-N,N-dimethylacetamide (Cpd 7);
(viii) 4-(aminomethyl)benzoate (Cpd 8);
(ix) 2-(4-(aminomethyl)phenyl)acetate (Cpd 9);
(x) methyl 4-(aminomethyl)benzoate (Cpd 10);
(xi) methyl 2-(4-(aminomethyl)phenyl)acetate (Cpd 11);
(xii) 1-(4-(aminomethyl)phenyl)propan-2-one (Cpd 12); and
(xiii) 1-(4-(aminomethyl)phenyl)ethan-1-one (Cpd 13).

The composition and process of the invention are particularly suited to use of benzylamine and we have found that the co-solvent significantly reduces the vapour pressure problems arising from the systems disclosed by Richner (Energy Procedia 37 (2013) 423-430).

Advantageously, compositions have lower susceptibility to thermal and oxidative degradation than a 30 wt % MEA solution due to the inherent chemical stability imparted by the aromatic ring structure. Preferably the cyclic absorption capacity of the solution for the target gas is comparable to that of a tertiary or sterically hindered amine solution and the rate of absorption of the target gas is comparable to or better than a 30 wt % MEA solution.

The solution is preferably a single phase liquid solution prior to the absorption of the acid gas as well as after the absorption of the acid gas (i.e. no precipitation of the reactants of the absorption process). The absorbent may be dissolved or disperse in one or more solvents. The solvent is typically an organic solvent, water or a combination thereof. The organic solvents are preferably a protic and/or a polar aprotic solvent. Suitable solvents that may be used include, but are not limited to, methanol, ethanol, propenol, glycols, carbonates (e.g. propylene carbonate), N-methyl-2-pyrrolidone, acetonitrile, dimethyl sulfoxide, dioxane, sulfolane, dimethylformamide, pyridine, acetone, dichloromethane, methyl ethyl ketone, chloroform, tetrahydrofuran, ethyl acetate, 2-butanone, toluene.

Ideally the target gas is an acidic gas. Preferably the target gas is selected from the group consisting of CO₂, NOₓ (where x is between 0.5 and 2), SO₂, H₂S, carbonyl sulphide, carbon disulfide, thiols or a halogen gas, such as Cl₂, F₂, I₂, or Br₂. More preferably the target gas is CO₂ or SO₂. Most preferably the target gas is CO₂. In an embodiment a number of target gases may be absorbed from a gas stream using the solution of the present invention, the target gases being selected from various combinations of CO₂, NOₓ, SO₂, H₂S or a halogen gas, such as Cl₂, F₂, I₂, or Br₂.

In the more preferred embodiment the target gas is CO₂.

In a set of embodiments the total of the absorbent compound component and water constitute at least 40%, preferably at least 50%, more preferably at least 60%, still more preferably at least 70% and even more preferably at least 80% (such as at least 90%) by weight of the total composition.

Preferably the solution is an aqueous solution. The use of an aqueous solution is advantageous for both economic and environmental reasons. The solvent may also be any protic solvent such as methanol, n-butanol or glycol or polar aprotic solvent such as ethylacetate or dimethylsulfoxide in which the acid gas and amine are jointly soluble. Furthermore, the target gas to be absorbed from the gas stream needs to be at least partially soluble in the solvent, so that the target gas is able to interact with the various constituents of the solution. Many of the gases of interest are at least partially soluble in water. In a preferred embodiment, the solvent comprises a mixture of water and a protic solvent (e.g. water and an alcohol) or water and a polar aprotic solvent. The selection of a co-solvent to replace part of the water as a solvent may influenced by improved characteristics of the co-solvent, resulting in a solvent mixture with increased acidic gas solubility, lower heat capacity or a higher boiling point.

In an embodiment R¹ to R⁵ are each independently selected from the group consisting of: H, hydroxyl, or C₁ to C₁₀ alkyl; R⁶ and R⁷ are independently selected from the group consisting of H, methyl, or ethyl. More preferably the absorbent compound is benzylamine or a benzylamine derivative. Most preferably the compound is benzylamine.

In one set of embodiments, the benzylamine and/or substituted benzylamine compound is present in the solution in a total amount of at least 1% (such as 1% to 70%) by weight based on the weight of the solution. The compound of formula 1 is preferably present in an amount between 1 wt % and 50 wt %, more preferably 1.5 wt % and 40 wt %, even more preferably between 2 wt % and 30 wt % and even more preferably between 5 wt % and 20 wt % based on the total weight of the solution. In a preferred embodiment, the upper limit of the benzylamine ?and/or substituted benzylamine compound is limited by the concentration which results in the precipitation of the reactants of the absorbent(s) and the absorbed acid gases. The upper limit of the compound of benzylamine and/or substituted benzylamine is preferably 70 wt %, more preferably 65 wt %, even more preferably 60 wt % and yet even more preferably 55 wt % of the total weight of the solution.

The total concentration of acidic gas absorbant compounds including the benzylamine/substituted benzylamine compounds is preferably at least about 10 weight %. More preferably the concentration is at least about 20 weight %. Even more preferably the concentration is at least about 30 weight %. Yet even more preferably the concentration is at least about 40 weight %. Most preferably the concentration is at least about 50 weight % or above 50 weight %.

Advantageously, the solution has a low viscosity and low corrosion potential. This allows the solution to contain the compounds at high concentration while still being able to maintain effective operating conditions. This provides for a solution with a large target gas absorption capacity and target gas absorption rate. Preferably the viscosity of the solution measured at 40° C. is less than 3mPa·s. More preferably, the viscosity of the solution is less than 2.75 mPa·s. Even more preferably, the viscosity is less than 2.5 mPa·s.

The at least one absorbent compound dissolved in the solvent will comprise the compound of formula (1) which may constitute the total of the gas absorbent compound or may be present in solution with other acidic gas absorbent compounds so that the total gas absorbent compounds comprise one or more gas absorbent compounds in addition to the compounds of formula (1). In one embodiment the solution contacted with the gas stream comprises one or more acidic gas absorbing compounds selected from amines and imidazoles in addition to the compound of formula (1). The one or more additional amines may be selected from primary, secondary and tertiary amines.

Examples of suitable amines include primary amines such as monoethanolamine, ethylenediamine, 2-amino-2-methylpropanol, 2-amino-2-methyl-ethanolamine and benzylamine; secondary amines such as N-methylethanolamine, piperazine, piperidine and substituted piperidine, diethanolamine, diglycolamine and diisopropanolamine; and tertiary amines such as N-methyldiethanolamine, and amino acids such as taurine, sarcosine and alanine.

In an embodiment, the solution further includes an additional amine compound, such as a tertiary or sterically hindered amine. The additional amine compound helps to avoid precipitation of the absorbent compound out of solution, which may be an issue at high weight loadings of the absorbent compound, and/or depending on the chemical environment of the solution. Suitable compounds may include for example: 2-amino-2-methyl-1-propanol (AMP), 3-piperidinemethanol, 3-piperidineethanol, 2-piperidinemethanol, 2-piperidineethanol, N-piperidinemethanol, N-piperidineethanol, 2-methylaminoethanol, N,N-dimethylaminoethanol and 3-quinclidinol. In some embodiments it is preferred that the compound is not monoethanolamine, diethanolamine, aminoethylethanolamine, Diglycolamine, piperazine, N-Aminoethylpiperazine, N-(2-hydroxyethyl) piperazine and morpholine

In a further embodiment, the solution comprises an imidazole and more preferably an N-functionalised imidazole. Suitable N-functionalised imidazoles may be found in U.S. Pat. No. 8,741,246, which in incorporated herein by reference.

The suitable N-functionalised imidazoles disclosed in U.S. Pat. No. 8,741,246 are of formula (2):

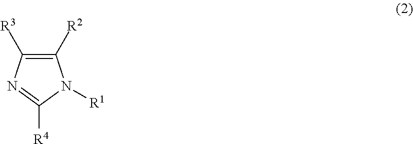

wherein

R¹ is substituted or unsubstituted C₁₋₂₀ alkyl, substituted or unsubstituted C₂₋₂₀ alkenyl, substituted or unsubstituted C₂₋₂₀ alkynyl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted cycloalkyl, substituted or unsubstituted heterocycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, cyano, or nitro; and

R², R³, and R⁴ are each independently selected from hydrogen, halogen, hydroxyl, substituted or unsubstituted C₁₋₂₀ alkyl, substituted or unsubstituted C₂₋₂₀ alkenyl, substituted or unsubstituted C₂₋₂₀ alkynyl, substituted or unsubstituted C₁₋₂₀ heteroalkyl, substituted or unsubstituted C₂₋₂₀ heteroalkenyl, substituted or unsubstituted C₂₋₂₀ heteroalkynyl, substituted or unsubstituted cycloalkyl, substituted or unsubstituted heterocycloalkyl, substituted or unsubstituted aryl, substituted or unsubstituted heteroaryl, substituted or unsubstituted thio, substituted or unsubstituted alkoxyl, aryloxyl, substituted or unsubstituted amino, cyano, or nitro.

Specific examples of such compounds include the 1-N—(C₁ to C₂₀ alkyl) imidazoles such as 1-butyl imidazole

In some, embodiment the solution comprises a combination of N-functionalised imidazoles and one or more amines.

The one or more amines which may be used in addition to the N-functionalised imidazoles may be selected from the group consisting of primary, secondary and tertiary amines including the specific examples of such amines referred to above.

The total wt % of the at least one absorbent compound in solution is preferably at least 20 wt %, more preferably at least 25 wt %, still more preferably at least 30 wt %, even more preferably at least 40 wt % and yet even more preferably at least 50 wt % relative to the total weight of the solution. This component will typically consists of the compound of formula (1) and optionally one or more compounds selected from amines and N-functionalised-imidazoles. The compound of chemical formula (1) preferably comprises at least 1% (e.g. 1% to 70%) more preferably between 1 wt % and 50 wt %, still more preferably between 1.5 wt % and 40 wt %, even more preferably between 2 wt % and 30 wt % and even more preferably between 5 wt % and 20 wt % relative to the total weight of the solution.

In another aspect of the invention there is provided a process for removing a target gas from a gas mixture including: contacting a gas mixture that is rich in target gas with an absorbent solution, as described above, to form a target gas rich solution and a gas mixture that is lean in target gas; and desorbing the target gas from the target gas rich solution. In yet a further set of embodiments there is further provided use of a compound of formula (1) in solution in a solvent at a concentration of at least 20% by weight, based on the total weight of the solution, for absorbing an acidic gas from a gas stream.

In one set of embodiments there is further provided a composition comprising a solution for an acidic gas comprising:
A. a solvent;
B. at least one absorbent compound comprising a compound which is benzylamine and/or substituted benzylamine (such as of formula (1); and
C. an absorbed acidic gas, preferably carbon dioxide, at a concentration above the equilibrium concentration when the solution is exposed to air at below the boiling point of the solvent.

Preferably, the concentration of the absorbed acidic gas is more than two times (and even more preferably five times) the equilibrium concentration when the solution is exposed to air at below the boiling point of the solvent, thus representing the absorbed acidic gas concentration in the solvent during the absorption process as previously described. The background amount of acidic gas, such as CO₂, will generally be less than 0.1% by weight based on the total weight of the solution. In one embodiment the absorbed acidic gas will constitute at least 0.2% by weight based on the total weight of the solution on absorption of the gas more preferably at least 1% and still more preferably at least 10% absorbed acidic gas by weight based on the total weight of the solution.

In one embodiment the solution comprises one or more amines in addition to the benzylamine and/or substituted benzylaminecompound which additional amines may, for example, be selected from primary, secondary and tertiary amines optionally including N-functionalised imidazoles such as those of formula (2).

In a set of embodiments the total of the absorbent component and water constitute at least 40%, preferably at least 50%, more preferably at least 60%, still more preferably at least 70% and even more preferably at least 80% (such as at least 90%) by weight of the total composition.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 illustrates a process for removing a target gas from a gas mixture according to the present invention.

FIG. 2 is a graph comparing the variation in total pressure of absorbents benzylamine (BZA) and monoethanolamine (MEA) with mole fraction in water expected from calculation with Raoult's law with the corresponding measured total pressure observed in practice.

FIG. 3 is a column chart presenting the experiment referred to in Example 3 where the vertical axis is a measure of the percent reduction in benzylamine vapour pressure for various co-solvent mixtures identified on the base line when compared with benzylamine alone.

FIG. 4 is a plot correlating the observed percentage reduction in benzylamine vapour pressure for a number of co-solvents with the RED in benzylamine (BZA) for the co-solvents as reported in Example 3.

FIG. 5 is a plot correlating the observed percentage reduction in benzylamine vapour pressure for a number of co-solvents with the RED in water for the co-solvents as reported in Example 3.

The invention relates to the use of an aqueous composition comprising a solution benzylamine, a benzylamine derivative, a benzylamine mixture, a benzylamine derivative mixture, or a combination thereof for absorbing an acid target gas from a gas stream wherein the aqueous composition comprises a co-solvent.

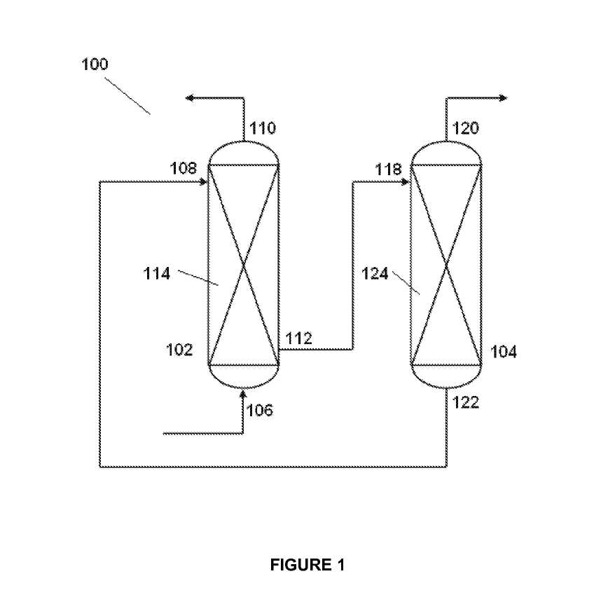

FIG. 1 provides an illustration of an embodiment of a process for capture of a target gas from a flue gas stream. In this particular embodiment, the target gas is CO₂. The process 100 includes an absorption reactor 102, for absorbing CO₂ from a flue gas stream, and a desorption reactor 104 for desorbing CO₂.

The absorption reactor 102 includes a first inlet 106, a second inlet 108, a first outlet 110, and a second outlet 112, and a gas absorption contact region 114. The first inlet 106 of the absorption reactor 102 is a flue gas inlet through which a CO₂ rich flue gas enters the absorption column 102. The second inlet 108 is an absorbent solution inlet through which a CO₂ lean absorbent enters the absorption column 102. The CO₂ rich flue gas and the CO₂ lean absorbent contact in the gas absorption contact region 114. In this region the CO₂ in the CO₂ rich flue gas is absorbed into the absorbent solution where it is bound in solution to form a CO₂ lean flue gas and a CO₂ rich absorbent solution.

The absorbent solution includes an benzylamine and/or substituted benzylamine absorbent and a co-solvent. In this particular embodiment, the absorbent molecule is benzylamine, e.g.:

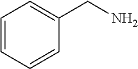

The local environment of the solution may be altered in the absorption column to favour the absorption reaction, e.g. to increase absorption of CO₂ into solution where it is bound to the benzylamine. Such alterations of the local environment may include a change in pH, a change in solution temperature, a change in pressure etc. Alternatively, or additionally, the solution may include other compounds which assist in the absorption of CO₂. These compounds may alter the affinity or absorption capacity of the benzylamine for CO₂, or these compounds may be also absorb CO₂.

If additional compounds are added to the absorbent solution in the absorption reactor 102, the process may additionally include means to remove these compounds.

The absorption of CO₂ from the CO₂ rich flue gas into the absorbent solution results in a CO₂ lean gas and a CO₂ rich absorbent solution. The CO₂ lean gas may still include some CO₂, but at a lower concentration than the CO₂ rich flue gas, for example a residual concentration of CO₂.

The CO₂ lean gas leaves the absorption column 102 through the first outlet 110, which is a CO₂ lean gas outlet. The CO₂ rich absorbent solution leaves the absorption column through the second outlet 112, which is a CO₂ rich absorbent outlet.

Desorption reactor 104 includes an inlet 118, a first outlet 120, a second outlet 122, and a gas desorption region 124. The CO₂ rich absorbent outlet 112 of the absorption column 102 forms the inlet 118 of the desorption column 104. Desorption of CO₂ from the CO₂ rich solution occurs in the gas desorption region 124.

Desorption of CO₂ from the CO₂ rich solution may involve the application of heat or a reduction in pressure to favour the desorption process. Furthermore, additional compounds may be added to the CO₂ rich solution to enhance the desorption process. Such compounds may alter the solution environment, for example by changing solution pH or altering another parameter to favour the desorption reaction.

Removal of CO₂ from the CO₂ rich solution results in the formation of a CO₂ gas stream and a CO₂ lean absorbent solution. The CO₂ lean absorbent solution may still include some CO₂, but at a lower concentration than the CO₂ rich solution, for example a residual concentration of CO₂.

The CO₂ gas stream is taken off via the first outlet 120, which is a CO₂ outlet. The CO₂ lean absorbent solution is taken off via the second outlet 122, which is a CO₂ lean absorbent solution outlet. The CO₂ lean absorbent is then recycled and fed through the second inlet 108 to the absorption column 102.

The invention will now be described with reference to the following Examples. It is to be understood that the examples are provided by way of illustration of the invention and that they are in no way limiting to the scope of the invention.

### EXAMPLES

Tabulated below in Table 1 are values for the Hansen Solubility Parameters of a number of potential co-solvents with a RED of <1.0. The value for benzylamine in water is also included for reference. For water R₀=13.9 and this value was used for the calculations of RED—values for the solubility of both water and benzylamine in co-solvents as the miscibility of benzylamine in water indicates they will share a similar R₀ value.

TABLE 1

| | Boiling | | | | | |
|---|---|---|---|---|---|---|
| | Point | | | | RED in | RED in |
| Compound | (° C.) | δ_{D} | δ_{P} | δ_{H} | BZA* | Water |
| benzylamine | 185 | 19.20 | 4.60 | 11.70 | — | 0.68 |
| water | 100 | 18.10 | 12.90 | 15.50 | 0.68 | — |
| aniline | 184 | 19.40 | 5.10 | 10.20 | 0.12 | 0.70 |
| ethylene glycol 2-ethylhexyl ether | 224 | 19.23 | 3.68 | 13.30 | 0.13 | 0.70 |
| 2,4-dimethylaniline | 194 | 19.20 | 5.20 | 8.70 | 0.22 | 0.76 |
| benzyl alcohol | 205 | 18.41 | 6.34 | 13.70 | 0.22 | 0.49 |
| decyl alcohol | 231 | 17.59 | 2.66 | 10.02 | 0.30 | 0.84 |
| 1-octanol | 196 | 16.98 | 3.27 | 11.86 | 0.33 | 0.76 |
| diethylene glycol propyl ether | 202 | 18.61 | 5.32 | 16.36 | 0.35 | 0.55 |
| 1,2-butylene carbonate | 251 | 16.98 | 6.14 | 9.82 | 0.36 | 0.66 |
| methoxypropyl acetamide | 256 | 19.23 | 8.80 | 8.80 | 0.37 | 0.59 |
| methoxyisopropyl acetamide | 232 | 19.64 | 8.80 | 8.59 | 0.38 | 0.62 |
| diethylene glycol butyl ether acetate | 235 | 16.57 | 5.73 | 13.70 | 0.41 | 0.58 |
| 1,2-hexane carbonate | 257 | 16.57 | 4.70 | 8.59 | 0.44 | 0.80 |
| 2-octanol | 174 | 16.16 | 4.91 | 11.05 | 0.44 | 0.71 |
| 1,2,3-triazole | 203 | 20.80 | 8.80 | 15.00 | 0.45 | 0.49 |
| 2-ethylhexyl acetate | 199 | 16.16 | 5.93 | 12.07 | 0.45 | 0.62 |
| methoxyisopropyl formamide | 231 | 18.00 | 10.02 | 9.41 | 0.46 | 0.48 |
| diethylene glycol ethyl ether acetate | 214 | 16.77 | 6.34 | 15.75 | 0.47 | 0.51 |
| diethyl succinate | 217 | 16.16 | 4.09 | 9.20 | 0.47 | 0.83 |
| 2-ethyl-1-hexanol | 183 | 15.95 | 3.27 | 11.86 | 0.48 | 0.80 |
| diethylene glycol methyl ether | 194 | 16.16 | 7.77 | 12.68 | 0.50 | 0.51 |
| diethylene glycol butyl ether | 230 | 15.95 | 6.95 | 10.64 | 0.50 | 0.63 |
| propylene glycol diacetate | 186 | 15.75 | 4.50 | 9.61 | 0.52 | 0.81 |
| ethylene glycol dibutyrate | 242 | 15.95 | 3.48 | 8.39 | 0.53 | 0.90 |
| tetraethylene glycol | 314 | 16.57 | 5.73 | 16.77 | 0.53 | 0.57 |
| 1,2-decane carbonate | 278 | 16.36 | 3.07 | 6.95 | 0.54 | 0.97 |
| diethylene glycol ethyl ether | 202 | 16.16 | 9.20 | 12.27 | 0.55 | 0.45 |
| 1,2-dodecane carbonate | 285 | 16.36 | 2.66 | 6.55 | 0.57 | 1.01 |
| tripropylene glycol methyl ether | 236 | 15.14 | 4.09 | 11.66 | 0.59 | 0.81 |
| ethylene glycol diacetate | 186 | 16.36 | 10.43 | 12.89 | 0.59 | 0.36 |
| triethyl phosphate | 215 | 16.77 | 11.45 | 9.20 | 0.63 | 0.50 |
| hexamethylphosphoramide | 255 | 23.11 | 8.59 | 11.25 | 0.63 | 0.84 |
| dipropylene glycol methyl ether acetate | 193 | 15.14 | 3.89 | 8.18 | 0.64 | 0.94 |
| 1,2-dimethyl imidazole | 204 | 17.39 | 12.68 | 10.64 | 0.64 | 0.36 |
| N-formyl morpholine | 236 | 16.57 | 11.66 | 10.02 | 0.64 | 0.46 |
| acetophone | 202 | 19.60 | 8.60 | 3.70 | 0.65 | 0.93 |
| di-n-butyl pthalate | 340 | 17.80 | 8.59 | 4.09 | 0.65 | 0.88 |
| N-methyl-2-pyrrolidinone | 202 | 18.00 | 12.27 | 7.16 | 0.66 | 0.60 |
| ethyl octanoate | 206 | 15.75 | 2.45 | 5.93 | 0.67 | 1.07 |
| dimethyl phthalate | 282 | 18.61 | 10.84 | 4.91 | 0.67 | 0.78 |
| diethyl pthalate | 298 | 17.59 | 9.61 | 4.50 | 0.67 | 0.83 |
| tri-n-butyl phosphate | 182 | 16.36 | 6.34 | 4.30 | 0.68 | 0.97 |
| 2-methyl-2,4-pentanediol | 197 | 15.75 | 8.39 | 17.80 | 0.72 | 0.50 |
| tripropylene glycol | 268 | 14.52 | 4.70 | 15.55 | 0.73 | 0.78 |
| benzonitrile | 188 | 17.39 | 9.00 | 3.27 | 0.73 | 0.93 |
| dipropylene glycol butyl ether | 228 | 14.32 | 7.98 | 11.86 | 0.74 | 0.70 |
| diethanolamine | 269 | 17.18 | 7.77 | 21.27 | 0.78 | 0.57 |
| n-butyl benzyl phalate | 370 | 19.02 | 11.25 | 3.07 | 0.78 | 0.91 |
| triethylene glycol | 285 | 16.60 | 12.50 | 18.60 | 0.84 | 0.31 |
| dimethyl sulfoxide | 189 | 18.41 | 16.36 | 10.23 | 0.86 | 0.46 |
| triethanolamine | 190 | 16.98 | 8.80 | 22.09 | 0.87 | 0.58 |
| iso-butyl heptyl ketone | 213 | 14.73 | 5.93 | 3.68 | 0.87 | 1.10 |
| methyl oleate | 218 | 14.52 | 3.89 | 3.68 | 0.89 | 1.19 |
| trimethyl phosphate | 197 | 16.77 | 15.95 | 10.23 | 0.89 | 0.48 |
| 2-pyrrolidinone | 245 | 19.43 | 17.39 | 11.25 | 0.92 | 0.48 |
| di-n-butyl sebacate | 345 | 13.91 | 4.50 | 4.09 | 0.94 | 1.18 |
| 2-phenoxyethanol | 237 | 13.70 | 10.43 | 15.95 | 0.95 | 0.66 |
| propylene glycol | 187 | 16.77 | 9.41 | 23.32 | 0.97 | 0.64 |
| sulfolane | 285 | 20.30 | 18.20 | 10.90 | 0.99 | 0.60 |
| toluene diisocyanate | 250 | 15.34 | 16.36 | 7.77 | 1.05 | 0.73 |
| diethylene glycol | 245 | 16.16 | 14.73 | 20.46 | 1.06 | 0.47 |
| monoethanolamine | 170 | 17.00 | 15.50 | 21.20 | 1.09 | 0.48 |
| ethylene glycol | 196 | 16.98 | 11.05 | 24.96 | 1.11 | 0.71 |
| propylene carbonate | 242 | 20.05 | 18.00 | 4.09 | 1.12 | 0.94 |
| diglycolamine | 221 | 11.86 | 11.05 | 19.23 | 1.27 | 0.95 |
| dipropylene glycol | 231 | 15.95 | 20.25 | 18.41 | 1.31 | 0.65 |
| ethylene carbonate | 248 | 19.43 | 21.68 | 5.11 | 1.32 | 1.00 |
| formamide | 193 | 17.18 | 26.18 | 19.02 | 1.67 | 1.00 |

*BZA = BenZylAmine.

### COMPARATIVE EXAMPLE

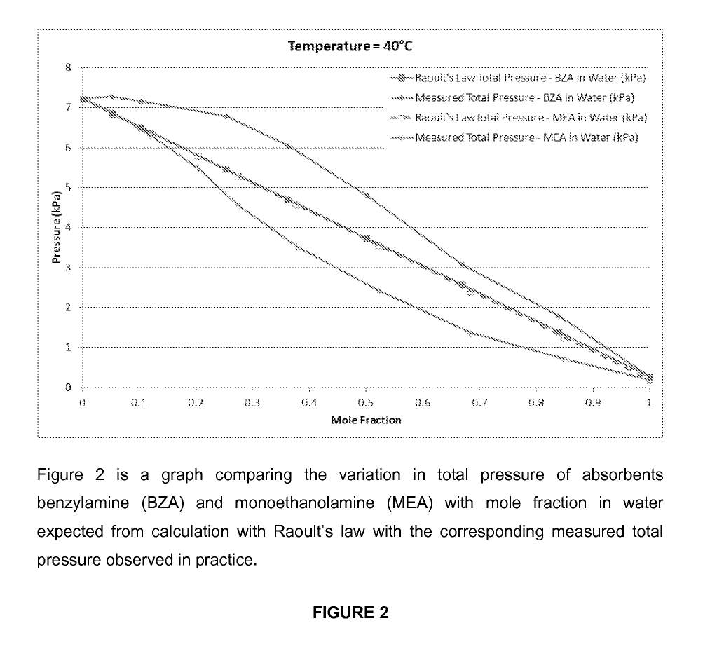

Referring to FIG. 2 there is shown a graph comparing the variation in total pressure of absorbents benzylamine (BZA) and monoethanolamine (MEA) with mole fraction in water expected from calculation with Raoult's law with the corresponding measured total pressure observed in practice. The total pressure as measured is higher than that predicted. This indicates that the intermolecular forces between liquid molecules are weakened in the mixture relative to the pure components. As an alternative example, aqueous solutions of monoethanolamine obey Raoult's law at low monoethanolamine mole fraction. At larger mole fraction the measured total pressure is below that predicted. This indicates no weakening of intermolecular forces between liquid molecules and intermolecular forces above a mole fraction of 0.1. Benzylamine would not be used above a weight fraction of 50%. This is a mole fraction of 0.15.

### Example 1

The CO₂ mass absorption capacity, expressed in kg CO₂/kg solvent (water) of several concentrations of benzylamine and a mixture (30 wt % and 50 wt % BA, and 50 wt % BA+10 wt % AMP) were tested at different partial pressures of CO₂ in a vapour-liquid-equilibrium (VLE) apparatus including a 160 ml glass vessel, a thermal bath, and a CO₂ dosing unit between 40° C. and 80° C. The method was validated by comparing measurements of CO₂ absorption by MEA 30 wt % with literature data. Results of this experiment are presented in FIG. 2. The amount of solvent circulating in a PCC process is linearly related to cyclic CO₂ mass absorption capacity of the solvent between the absorption (rich) and desorption (lean) column temperatures. Concentrated benzylamine solvents show superior absorption capacity compared to MEA 30 wt %, but the concentration of BA is limited by precipitation. The optimal concentration of BA, is at the limit of precipitation when at equilibrium with 15 kPa CO₂. At this concentration, the cyclic capacity is estimated to be 0.04 kg CO₂/kg solvent, compared with 0.021 kg CO₂1 kg solvent for MEA 30 wt %.

We have found as a result of our further work testing benzylamine in a pilot scale CO₂ absorption facility, that benzylamine develops a relatively high vapour pressure in aqueous solutions detracting from the advantages reported by Richner. We observed emission of unreacted benzylamine from the absorber column during operation. This emitted benzylamine further reacted with residual CO₂ in the gas stream forming a precipitate and blocking the absorber outlet as well as resulting in a reduction in capture performance of the absorbent.

The high vapour pressure of benzylamine observed in the trials may be significantly resuced by inclusion of a volume such as 10% v/v of the composition of a co-solvent such as listed in Table 1.

### Example 2

The mass transfer coefficient of CO₂ absorption (Kg, mmol·m⁻²s⁻¹ kPa⁻¹) in benzylamine and benzylamine mixtures may been measured at 40° C. The CO₂ loading (mol CO₂/mol amine) of the liquid may also be varied. The measurements are made using a wetted-wall contactor in which the rate of CO₂ absorption is measured into a falling liquid film of known surface area at atmospheric pressure. This device mimics the gas-liquid contacting of a packed column. Details of the device and experimental procedure can be found in G. Puxty, et al., Chem. Eng. Sci., 65 (2010), 915-922.

### Example 3

### Benzylamine Vapour Pressure Measurements

This Example examines the benzylamine vapour pressure generated in an aqueous mixture with a range of co-solvents.

Procedure:
100 to 200 g aqueous solutions containing 30 wt % benzylamine and 30 wt % additive listed in Table 2 were prepared using an analytical balance. The solutions were then placed in a glass gas tight vessel and immersed in a water bath at 40° C. and allowed to thermally equilibrate. An inlet and outlet port from the top of the glass vessel were connected to the inlet and outlet port of a GASMET FTIR gas analyser via heated lines at 180° C. The head space of from the glass vessel was recirculated via a pump through the GASMET analyser. The GASMET analyser, which was factory calibrated to measure gas phase benzylamine concentration, was then used to measure the concentration of benzylamine in the head space (in ppm). Recirculation of the gas was continued until a stable reading was reached (approximately 30-60 minutes).

The results of the measurements are shown in Table 2

TABLE 2

| 30 wt % Additive | 30 wt % Benzylamine vapour pressure (ppm) |
|---|---|
| none | 753 |
| ethylene glycol | 518 |
| triethylene glycol | 703 |
| imidazole | 440 |
| 1-methyl-2-pyrrolidinone | 547 |
| dichloropyridine | 642 |
| 4-(aminomethyl)pyridine | 752 |
| 1,2-dimethylimidazole | 573 |
| Sulfolane | 532 |
| 1,2,4-triazole | 474 |
| 1-(3-aminopropyl)imidazole | 745 |

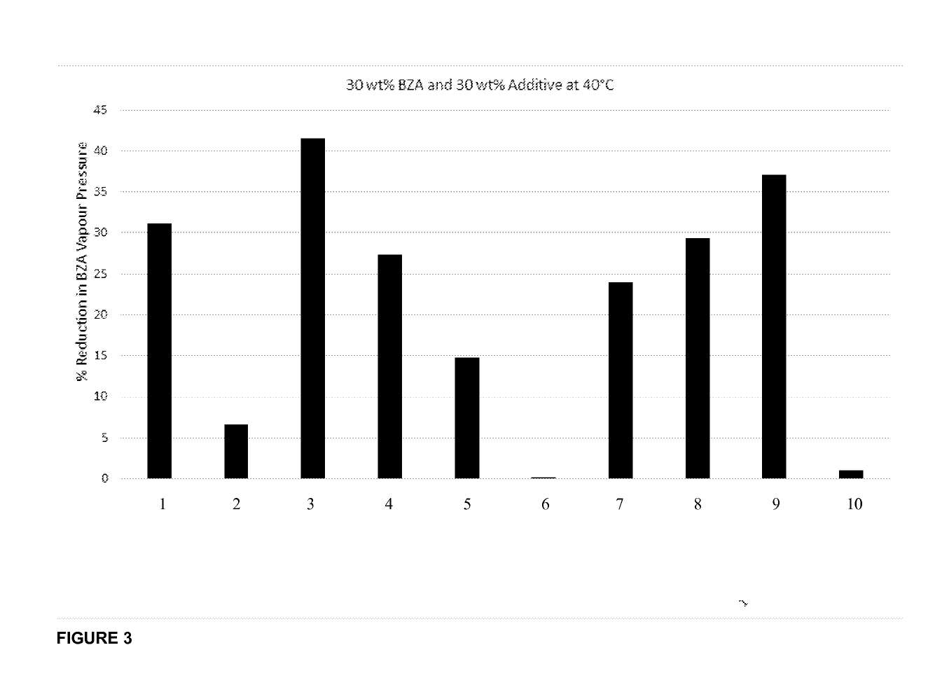

The results are presented in the column chart in FIG. 3 in which the base line numerals refer (from left to right) to the co-solvents listed in Table 3:

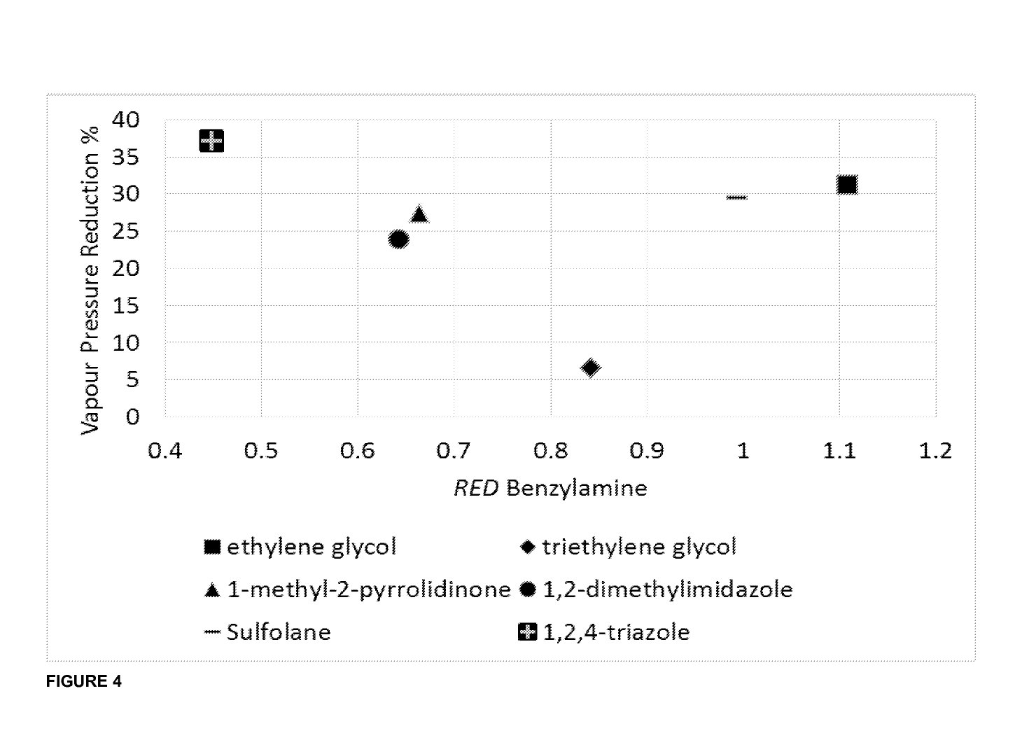

TABLE 3

| FIG. 3 No. | | FIG. 4, 5 symbol |
|---|---|---|
| 1. | ethylene glycol | ▪ |
| 2. | triethylene glycol | ♦ |
| 3. | imidazole | |
| 4. | 1-methyl-2-pyrrolidinone | ▴ |
| 5. | dichloropyridine | |
| 6. | 4-(aminomethyl)pyridine | |
| 7. | 1,2-dimethylimidazole | |
| 8. | Sulfolane | − |
| 9. | *1,2,4-triazole | + |
| 10. | 1-(3-aminopropyl)imidazole | |

*Hansen solubility data for the 1,2,3-triazole isomer used.

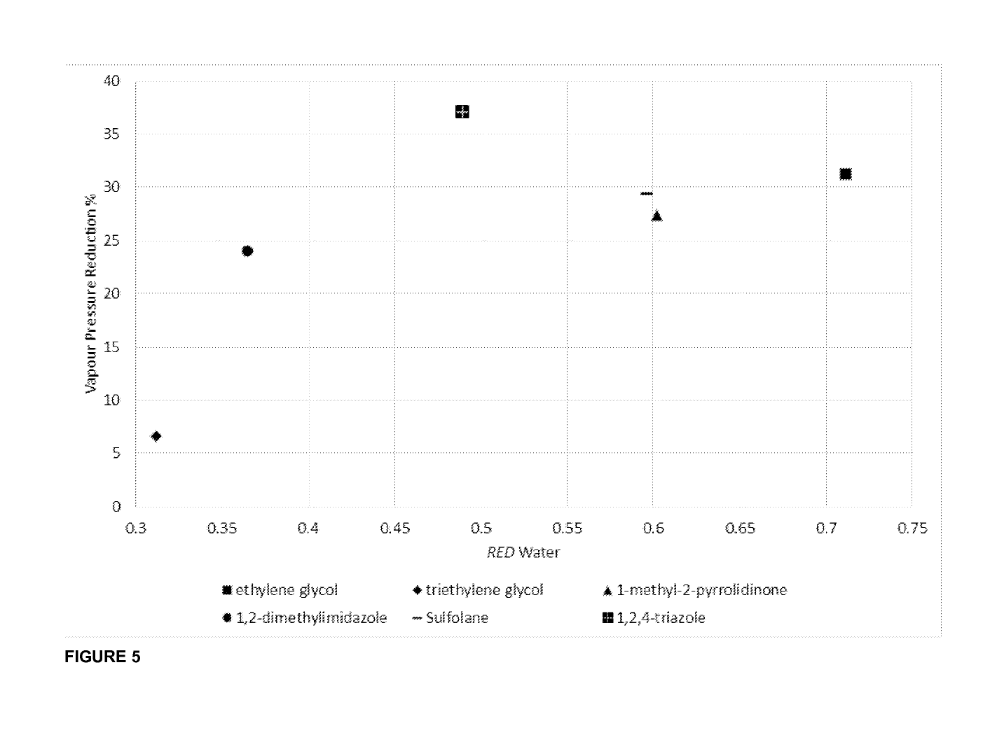

A number of these compounds can be compared to the Relative Energy Difference (RED) as estimated using the Hansen Solubility Parameters (tabulated previously). The RED value in either benzylamine or water indicates the likely solubility of the compound in each respectively. The percent reduction in benzylamine (BZA) vapour pressure is correlated with the RED for the co-solvents in benzylamine and water in FIGS. 4 and 5 respectively. Many of the co-solvents in Table 3 are examined using the symbols identified in Table 3. The smaller the RED value the greater the solubility. For benzylamine there is little change in extent of vapour pressure reduction for the covered range of RED values (0.45-1.1) with the exception of triethylene glycol. In the case of water there is a consistent decrease in vapour pressure reduction with decreasing RED value. Triethylene glycol has the smallest RED for water (0.31) and the smallest vapour pressure reduction (6.6%). This suggests that excessively strong interaction with water (and therefore a small RED value) has a detrimental impact upon vapour pressure reduction, while the strength of interaction with benzylamine has less of an influence. This suggests that preferable compounds will have RED values in water of at least 0.4 and RED values in benzylamine of no more than about 1.2.

### Example 4

### Benzylamine in admixture with imidazole in aqueous solution

Mixtures of benzyamine (BZA) and imidazole (IMD) were prepared in aqueous solution at various concentrations with the solutions being saturated in CO₂. The presence of precipitates was observed and recorded.

The following Table 3, where indicated by X or O, shows the solutions tested and the results are presented where “O” refers to the absence of precipitate and “X” the presence of precipitate.

TABLE 3

| | | IMD (mol/L) | | | | |
|---|---|---|---|---|---|---|
| | | 1 | 2 | 3 | 4 | 5 |
| BZA | 1 | ◯ | | | | ◯ |
| (mol/L) | 2 | X | | | | |
| | 3 | | | | | |
| | 4 | | | | ◯ | |
| | 5 | ◯ | | | | ◯ |

1. A process for absorbing target acidic gas from a gas stream rich in the target acidic gas comprising contacting the gas stream with an aqueous composition comprising at least one absorbent compound comprising benzylamine and/or substituted benzylamine dissolved in the aqueous composition wherein the aqueous composition comprises a co-solvent which reduces the vapour pressure of the absorbent compound in the aqueous solution.

2. A process according to claim 1, wherein the co-solvent has both non-polar and polar character including a functional group capable of hydrogen bonding.

3. A process according to claim 1, wherein the Relative Energy Difference solubility parameter (RED) of the co-solvent in each of benzylamine and water is no more than 1.2.

4. A process according to claim 1, wherein the benzylamine and/or substituted benzylamine has an vapour pressure in the aqueous composition in the absence of the co-solvent which is in practice is greater than the theoretical vapour pressure determined by Raoult's law and the co-solvent provides a vapour pressure of no more than said theoretical vapour pressure.

5. A process according to claim 1, wherein the co-solvent maintains a vapour pressure of benzylamine/and or substituted benzylamine in the aqueous solution of below 0.04 kPa at 40° C.

6. A process according to claim 1, wherein the absorbent comprises benzylamine.

7. A process according to claim 1, wherein the co-solvent has a boiling point of at least 150° C.

8. A process according to claim 1, wherein the co-solvent comprises at least one selected from the group consisting of aniline and aniline derivatives, glycols, glycol derivatives selected from the group consisting of, glycol ethers, glycol ether esters, glycol esters, long chain aliphatic and aromatic alcohols, amides, esters, ketones, phosphates, nitrogen containing heteroaromatics, amines, organic carbonates and organosulfur compounds.

9. A process according to claim 1, wherein the co-solvent comprises at least one selected from the group consisting of
(a) glycols and glycol derivatives selected from glycol mono ethers, glycol diethers, glycol ether esters and glycol monoesters and glycol diesters;
(b) aniline and substituted anilines where the substituent is from the group consisting of one or more C1 to C4 alkyl groups;
(c) C₆ to C₁₄ alcohols selected from aliphatic alcohols, aromatic alcohols, aromatic substituted aliphatic alcohols and aliphatic substituted aromatic alcohols;
(d) amides selected from the group consisting of acetamides selected from C₁ to C₆ acetamides, di-(C₁ to C₆ alkyl) acetamides and alkyl acetamides substituted on said alkyl by a substituent selected from hydroxyl and C₁ to C₆ alkoxy, formamides selected from the group consisting of C₁ to C₈ alkyl formamides and C₁ to C₆ alkyl formamides substituted in the alkyl group by a substituent selected from hydroxyl and C₁ to C₆ alkoxy and cyclic amides having 5 or 6 ring members optionally substituted by C₁ to C₆ alkyl;
(e) esters formed between an acid selected from C₁ to C₂₀ aliphatic acids and alcohols or polyols selected from C₁ to C₁₀ hydrocarbyl alcohols and polyols;
(f) mono- or di-esters if a diacids selected from C₄ to C₁₀ di-acids wherein the alcohol portions are C₁ to C₆ alkanol;
(g) phosphate esters selected from di-(C₁ to C₈ alkyl) and tri-(C₁ to C₈ alkyl) phosphate esters;
(h) nitrogen containing heteroaromatics containing from 1 to 3 nitrogen ring atoms in a 5 or 6 membered aromatic ring optionally containing one further heteroatom selected from oxygen and sulphur, wherein the heteroaromatic ring may optionally be substituted by one or two substituents independently selected from C₁ to C₆ alkyl and halo;
(i) amines selected from the group of primary, secondary and tertiary amines wherein the amine may be part of a heterocyclic ring of from 5 to 6 ring members and wherein the substituents are selected from C₁ to C₂₀ aliphatic and C₁ to C₆ aliphatic substituted by hydroxyl, glycol or PEG of molecular weight 200 to 600;
(j) substituted carbonate selected from di-C₁ to C₂₀ aliphatic carbonates;
(k) organic sulphur compounds selected from di-(C₁ to C₁₀ hydrocarbyl) sulfoxides, di-(C₁ to C₁₀ hydrocarbyl)sulfones and cyclic sulfones; and
(l) a phosphoramides.

10. A process according to claim 1, wherein the co-solvent comprises at least one glycol or derivative thereof selected from the group consisting of C₁ to C₈ alkylene glycols; di-C₁ to C₄ alkylene glycols, tri-C₁ to C₄ alkylene glycols tetra-C₁ to C₄ alkylene glycols and polyalkylene glycols of molecular weight 200 to 600 and derivatives thereof selected from the group consisting of mono-(C₁ to C₆ alkyl)ethers and di-(C₁ to C₆ alkyl)ethers of said glycols, C₁ to C₆ ether (C₁ to C₆ alkanoyl)esters of said glycols and mono-(C₁ to C₆ alkanoyl)esters and di-C₁ to C₆ alkanoyl esters of said glycols.

11. A process according to claim 1, wherein the co-solvent comprises at least one nitrogen containing heteroaromatic selected from imidazole, triazole and pyriding optionally substituted with one or two substituents selected from C₁ to C₆ alkyl and chloro.

12. A process according to claim 1, wherein the co-solvent comprises at least one selected from the group consisting of:
(a) glycols selected from the group consisting of ethylene glycol, propylene glycol, diethylene glycol, tripropylene glycol and tetraethylene glycol;
(b) monoethers of glycols and di-ethers of glycols selected from the group consisting of diethylene glycol propyl ether, diethylene glycol methyl ether, diethylene glycol diethylene glycol butyl ether, diethylene glycol ethyl ether, tripropylene glycol methyl ether, dipropylene glycol butyl ether;
(c) glycol ether esters be selected from the group consisting of diethylene glycol butyl ether acetate, diethylene glycol ethyl ether acetate and dipropylene glycol methyl ether acetate;
(d) diesters of glycols selected from the group consisting of propylene glycol diacetate, ethylene glycol dibutyrate and ethylene glycol diacetate;
(e) anilines selected from the group consisting of aniline and 2,4-dimethylaniline;
(f) acetamides selected from the group consisting of methoxypropylacetamide and methoxyisopropylacetamide;
(g) alcohols selected from the group consisting of octanol, decyl alcohol and benzyl alcohol;
(h) formamides selected from formamide, N-formyl morpholine and methoxyisopropyl formamide;
(i) pyrrolidinones selected from pyrrolidone and N-methylpyrrolidone;
(j) esters selected from 2-ethylhexyl acetate, ethyloctanoate and methyl oleate;
(k) diesters of dicarboxylic acids selected from the group consisting of diethylsuccinate, diethyl phthalate, dimethylphthalate, di-n-butyl sabacate;
(l) ketones selected from isobutyl heptyl ketone and acetophenone;
(m) carbonates selected from the group consisting of 1,2-dodecane carbonate, ethylene carbonate and propylene carbonate;
(n) phosphate aster which is trimethyl phosphate or triethylphosphate;
(o) Imidazoles selected from imidazole and 1,2-dimethylimidazole;
(p) sulphur compounds selected from DMSO and sulfolane; and
(q) phosphoramide which is hexamethylphosphoramide.

13. A process according to claim 1, wherein the co-solvent is selected from the group consisting of ethylene glycol, propylene glycol, imidazole 1-methyl-2-pyrrolidone, dichloropyridone, 1,2-dimethylimidazole, sulfolane, 1,2,4-triazole and 1,2,3-triazole.

14. A process according to claim 1, wherein the co-solvent is present in an amount in the range of from 1% to 20% by volume based on the volume of the aqueous composition.

15. A process according to claim 1, wherein the volume ratio of co-solvent: benzylamine and/or substituted benzylamine is in the range of from 1:20 to 1:1.

16. A process according to claim 1 wherein the benzylamine and/or substituted benzylamine is of formula (1): 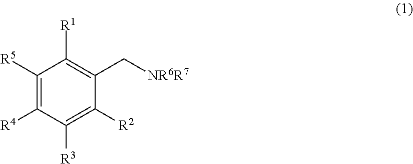
wherein R¹ to R⁵ are each independently selected from the group consisting of: H, hydroxyl, substituted or unsubstituted C₁ to C₂₀ alkyl, substituted or unsubstituted C₂ to C₂₀ alkenyl, substituted or unsubstituted C₂ to C₂₀ alkynyl, substituted or unsubstituted aryl, substituted or unsubstituted heterocycle, substituted or unsubstituted carbonyl, substituted or unsubstituted aldehyde, substituted or unsubstituted carboxylate, substituted or unsubstituted ester, substituted or unsubstituted alkoxy, substituted or unsubstituted carboxamide, substituted or unsubstituted imine, NR⁶R⁷, N═CR⁸R⁹, and halo; and
R⁶ and R⁷ are each independently selected from the group consisting of: H, substituted or unsubstituted C₁ to C₂₀ alkyl, substituted or unsubstituted C₂ to C₂₀ alkenyl, and substituted or unsubstituted C₂ to C₂₀ alkynyl;
wherein R⁸ and R⁹ are independently selected from the group consisting of H, substituted or unsubstituted C₁ to C₂₀ alkyl, substituted or unsubstituted C₂ to C₂₀ alkenyl, and substituted or unsubstituted C₂ to C₂₀ alkynyl substituted or unsubstituted aryl, substituted or unsubstituted heterocycle, substituted or unsubstituted carbonyl, substituted or unsubstituted aldehyde, substituted or unsubstituted carboxylate, substituted or unsubstituted ester, substituted or unsubstituted alkoxy, substituted or unsubstituted carboxamide, substituted or unsubstituted imine, NR⁶R⁷, and halo; and
when any of R¹ to R⁵ is a substituted C₁ to C₂₀ alkyl, the substituted C₁ to C₂₀ alkyl is selected from the group consisting of: haloalkane, alkyl sulfide, hydroxyalkyl, alkyl thiol, alkyl sulfonate, alkyl phosphine, alkyl phosphate, alkyl phosphonate, alkyl ether, alkyl alkanoate, alkyl hydroperoxide alkyl peroxide, alkyl cyanate, alkyl isocyanate, alkyl cyanide, alkyl nitrate, alkyl nitrite, alkyl amide, alkyl imine, alkyl imide, alkyl azide, alkyl diazine, and alkyl nitrite;
and wherein the at least one absorbent compound is in the solution at a concentration of at least about 20% by weight based on the total weight of the solution.

17. The process of claim 1, wherein the at least one absorbent compound is in the solution at a concentration of at least about 30 weight %.

18. The process of claim 1, wherein the at least one absorbent compound is in the solution at a concentration of at least about 40 weight %.

19. A process according to claim 1, wherein the absorbent component and water constitute at least 50% by weight of the total composition.

20. The process of claim 1, wherein the viscosity of the solution at 40° C. is less than about 2.5 mPa·s.

21. The process of claim 1, where the at least one absorbent compound further comprises an additional amine compound.

22. The process of claim 21, wherein the additional amine compound is a tertiary or sterically hindered amine.

23. The process of claim 21, wherein the concentration of the benzylamine and/or substituted benzylamine is in the range of 1 wt % and 65 wt %.

24. The process of claim 1, further comprising desorbing the target gas from the target gas rich solution.
